(19) United States
(12) Patent Application Publication
(10) Pub. No.: US 2012/0143776 A1
(43) Pub. Date: Jun. 7, 2012

(54) PHARMACOVIGILANCE ALERT TOOL

(75) Inventors: Karen JAFFE, Irvine, CA (US); Michael BRAUN-BOGHOS, Munchen (DE)

(73) Assignee: ORACLE INTERNATIONAL CORPORATION, REDWOOD SHORES, CA (US)

(21) Appl. No.: 12/961,832

(22) Filed: Dec. 7, 2010

(51) Int. Cl. G06Q 99/00; G06Q 50/00

(52) U.S. Cl. 705/317

(57) ABSTRACT

Systems, methods, and other embodiments associated with providing an alert when alert criteria is met by monitored AE data analysis output. An alert criteria is specified that corresponds to desired results of at least two different instances of AE data analysis. The alert criteria is assessed on at least one data source. A case series that meets the alert criteria is output.

### BACKGROUND

In the field of pharmacovigilance (PV), reports of adverse reactions to drugs (typically called adverse events (AEs)) are received by reporting systems at biopharmaceutical, device, or contract research organization (CRO) companies. These AE reports come from healthcare professionals such as pharmacists and physicians. Data summarizing the AEs is stored in large databases and the data is analyzed to detect “signals.” In the pharmacovigilance context, a “signal” is defined as reported information on a possible causal relationship between an AE and a drug that was previously unknown or incompletely documented.

In general, two types of analysis are performed on the data to detect signals: quantitative and qualitative. Quantitative analysis involves statistically analyzing the AE data to identify AE types that occur more often than other AE types in the data. Quantitative analysis can be performed automatically to determine unknown risks. Qualitative analysis involves testing a hypothesis that specifies a particular AE type by analyzing AE data contained within AE reports and other information sources to confirm the hypothesis. Qualitative analysis is aimed at testing data for a predefined risk.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a schematic overview of a signal detection process that includes an example embodiment of an alert tool.

FIG. 2 illustrates an example embodiment of a method associated with an alert tool.

FIG. 3 illustrates another example embodiment of a method associated with an alert tool.

FIG. 4 illustrates an example embodiment of a system associated with an alert tool.

FIG. 5 illustrates an example embodiment of a system associated with an alert tool.

FIG. 6 an example computing environment in which example systems and methods, and equivalents, may operate.

### DETAILED DESCRIPTION

Signal detection is a central objective of pharmacovigilance because the risk/benefit evaluation performed to determine whether to approve drugs for use by the general population depends on the effective detection of signals. Signals identify an adverse event (AE) type (a drug and side effect combination) that should be investigated. Methods for signal detection include qualitative analysis based on observations by clinicians and patients, case reports in the literature, assessment of individual reports or clusters of reports in spontaneous reporting systems and signals detected in observational databases and clinical trials. Thus detection of signals using qualitative analysis typically requires clinical assessment assisted by epidemiological and statistical analyses.

Methods for signal detection also include quantitative analysis techniques that leverage information technology tools. Automated quantitative analysis compares the reported safety profile of a medicine with other products in the database using statistical methods such as proportional reporting rates. Because the number of potential signals identified by automated quantitative analysis can be large, analysts can become overwhelmed with potential signals, making it difficult to identify potential signals that merit further investigation.

Currently, there is no mechanism to screen the output of the various analyses and to alert an analyst when certain combinations of analysis outputs occur. For example, when a particular AE type (i.e., a combination of a drug and a side effect) is identified using qualitative analysis and has also been independently verified using quantitative analysis, it may be desirable to prioritize that AE type over other AE types that have not been identified using both qualitative and quantitative analysis.

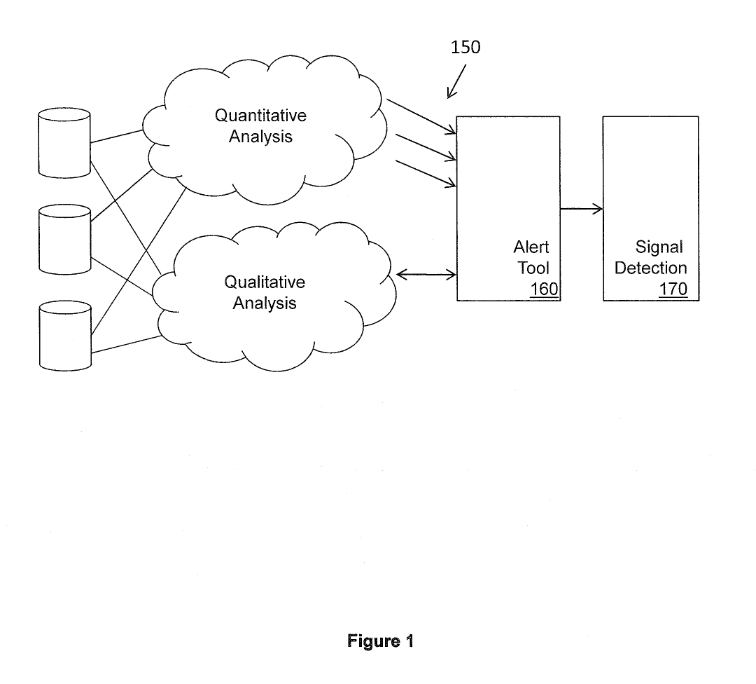

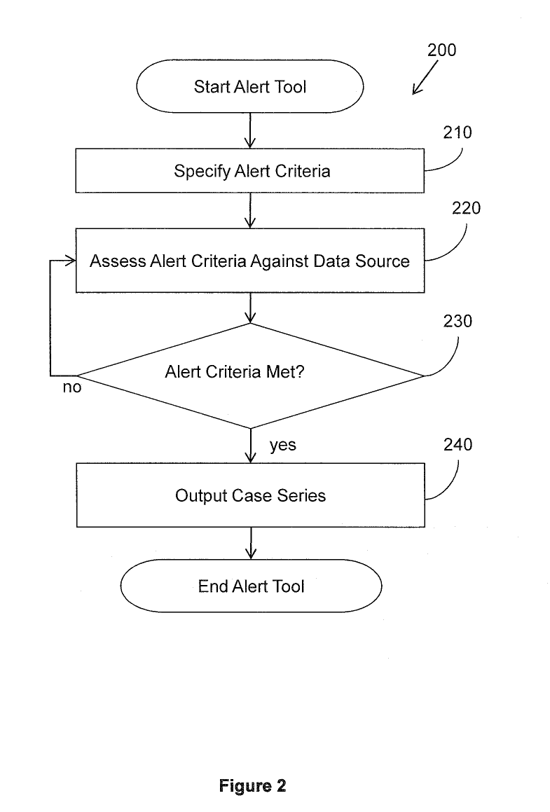

FIG. 1 is a schematic overview of a signal detection system 150 that includes an alert tool 160. AE data analysis is shown being performed on multiple data sources. The alert tool alerts a signal detection process 170 when certain alert criteria is met. Thus, the signal detection process 170 can screen the outputs of the qualitative and quantitative analyses prior to notifying an analyst (not shown) that an AE type that may be a signal has been detected. An alert tool, which will be described in more detail below with respect to FIGS. 2-6, may be used to specify criteria that are to be used to screen results of AE data analysis and to alert an analyst that the criteria have been met.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Logic”, as used herein, includes but is not limited to hardware, firmware, instructions stored in a non-transitory computer-readable medium or in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional blocks that are not illustrated.

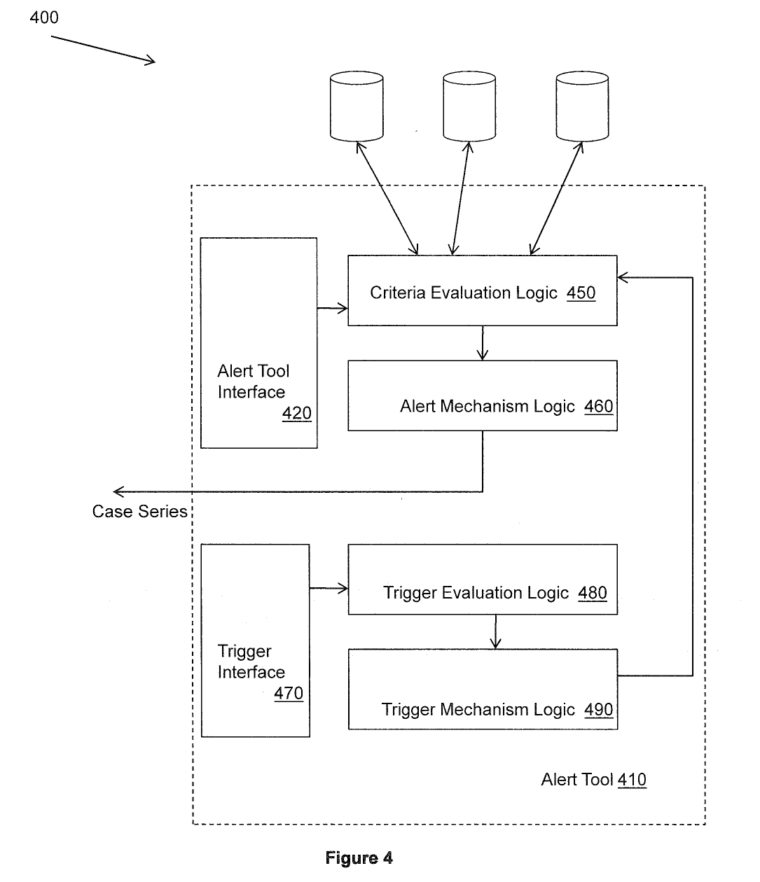

FIG. 2 is a flow diagram outlining an example embodiment of a method 200 that can be used to provide an alert tool for use in pharmacovigilance. The method includes, at 210 specifying an alert criteria. A user of an alert tool interface (see FIG. 4) can specify the alert criteria, which may include a Boolean operation on different instances of AE data analysis performed on specified data sources. In addition to Boolean operations, the user may also specify a threshold with respect to specific statistical algorithms that are used to generate quantitative analysis outputs. Statistical algorithms include a Reporting Odds Ratio (ROR) and a Proportional Reporting Ratio (PRR). For example, an alert criteria with respect to a given drug and side effect may specify that a qualitative analysis output AND at least two ROR outputs OR three (PRR) outputs that identify the drug and side effect will generate an alert.

At 220 the alert criteria is assessed against specified data sources. At 230 results of the assessment at 220 are evaluated with respect to the alert criteria. At 240 one or more case series are output when the alert criteria is met by the results of the assessment. Thus, the alert tool method 300 outputs one or more case series that meet the alert criteria. A case series is a listing of AEs that meet the alert criteria. A case in the case series includes details about an AE, such as patient health information, drug dosage, and information about the patient's specific reaction to the drug. The case series provides information that an analyst would typically review in the course of determining whether a signal has been detected.

By way of example, an analyst may specify an alert criteria that includes a qualitative analysis performed on six different data sources and a quantitative analysis on six other different data sources. The signal detection system with the alert tool will assess the alert criteria on the twelve different data sources. If any AE types are identified by both the qualitative analysis and the quantitative analysis, a case series of AEs that meet the alert criteria is output. In other examples, the alert criteria could include multiple instances of qualitative or multiple instances of quantitative analysis, but not a combination of qualitative and quantitative analysis.

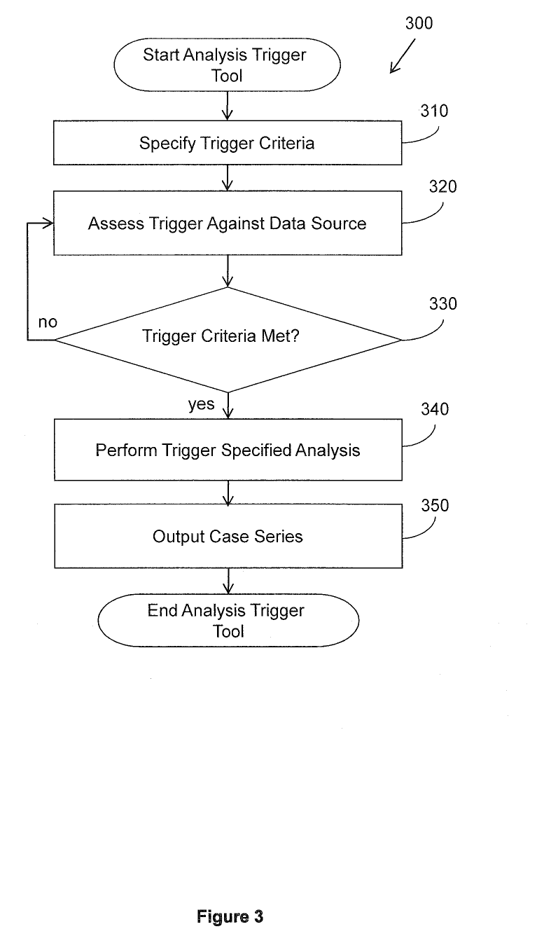

FIG. 3 is a flow diagram outlining an example embodiment of a method 300 that can be used to trigger subsequent AE data analysis when trigger criteria have been met. At 310 a trigger criteria is specified. The trigger criteria includes at least one instance of AE data analysis and may include a Boolean operation on different instances of AE data analysis on different data sources. For example, a trigger criteria could specify a qualitative analysis output for a given AE or a threshold number of quantitative analysis outputs that will trigger subsequent AE data analysis. At 320, the trigger criteria is assessed against the specified data sources. At 330, the method evaluates the results of the AE data analysis with respect to the trigger criteria.

At 340, the method initiates a predetermined subsequent instance of AE data analysis when the trigger criteria is met by results of the AE data analysis. The subsequent AE data analysis may be, for example, a specific statistical algorithm that is to be performed on the same dataset from which the triggering analysis output was deduced. The subsequent AE data analysis may also be performed on a different data source, possibly to confirm results obtained from the first dataset. The trigger mechanism causes the analysis to be performed and the results of the subsequent analysis may be compared with another trigger mechanism or alert criteria. At 350, a case series is output that results from the subsequent AE data analysis. In some embodiments, the case series is output when it meets an alert criteria.

Alert criteria and trigger criteria may be constructed in multiple levels such that a first trigger criteria that specifies a qualitative analysis output may cause a first statistical algorithm to be performed and the results compared to a first alert criteria or a second trigger criteria and so on. In this manner the user may be able to execute one or more statistical algorithms in Boolean succession, and test the outputs each of these algorithms against a respective threshold prior to declaring that a signal has been detected. A case series may or may not be generated at each level of criteria.

While FIGS. 2 and 3 illustrate various actions occurring in serial, it is to be appreciated that various actions illustrated in FIGS. 2 and 3 could occur substantially in parallel. By way of illustration, a first process could specify an alert criteria, a second process could assess the alert criteria, and a third process could output the case series. Also by way of illustration, a first process could specify a trigger criteria, a second process could assess the trigger criteria, and a third process could initiate subsequent AE data analysis. While in either illustration, three processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium is a non-transitory medium that stores computer executable instructions that if executed by a machine (e.g., processor) cause the machine to perform a method that includes specifying an alert criteria corresponding to desired results of at least two different instances of AE data analysis; assessing the alert criteria on at least one data source; and outputting a case series that meets the alert criteria.

The method may also specify a trigger criteria corresponding to desired results of at least a first instance of AE data analysis and initiate a predetermined second instance of AE data analysis when the trigger criteria is met. While executable instructions associated with the above method are described as being stored on a computer-readable medium, it is to be appreciated that executable instructions associated with other example methods described herein may also be stored on a computer-readable medium.

FIG. 4 is a block diagram illustrating a signal detection system 400 that includes an alert tool 410 that outputs a case series when alert criteria have been met. The alert tool 410 includes an alert tool interface 420 configured to allow construction of an alert criteria that includes a combination of AE data analysis output from at least two different instances of AE data analysis. A criteria evaluation logic 450 is configured to assess the alert criteria against specified data sources. When the criteria evaluation logic 450 identifies results of AE data analysis that meet the alert criteria, the criteria evaluation logic causes an alert mechanism logic 460 to output a case series that meets the alert criteria.

The alert tool 410 shown in FIG. 4 also includes logic units that provide the trigger functionality described in FIG. 3. A trigger interface 470 allows construction of a trigger criteria that includes at least a first instance of AE data analysis. A trigger evaluation logic 480 assesses the trigger criteria against specified data sources. When the trigger evaluation logic 480 identifies results of AE data analysis that meet the trigger criteria, the trigger evaluation logic 480 causes the trigger mechanism logic 490 to prompt the criteria evaluation logic 450 to initiate a predetermined instance of AE data analysis. If the criteria evaluation logic 450 identifies results of AE data analysis that meet the alert criteria, the criteria evaluation logic causes the alert mechanism logic 460 to output a case series that meets the alert criteria.

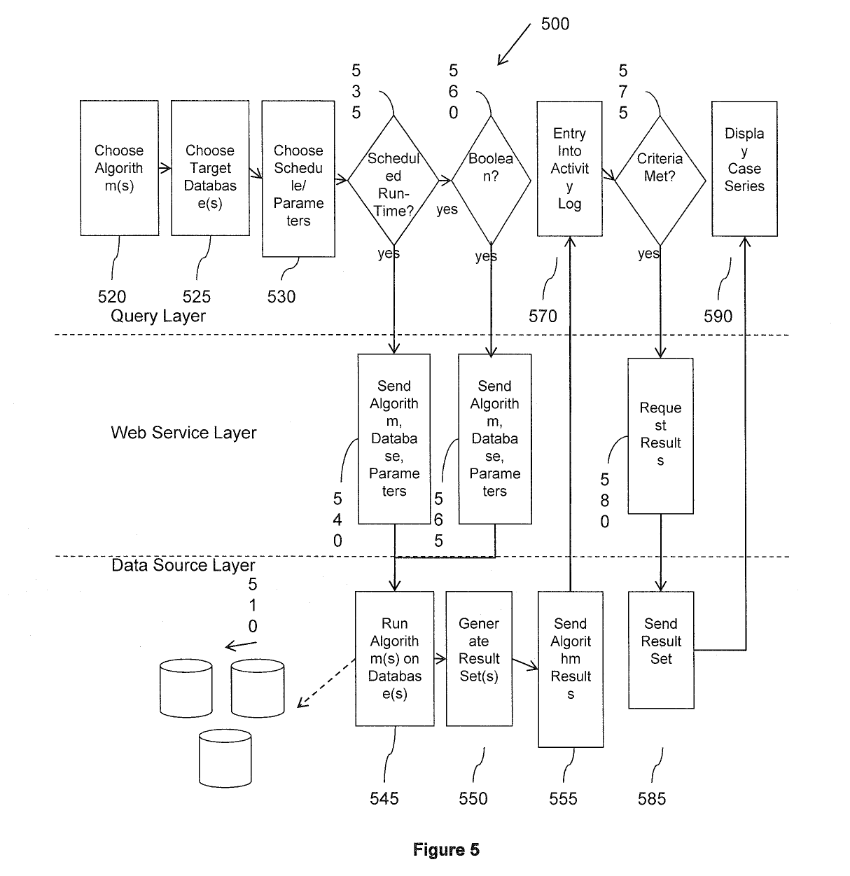

FIG. 5 illustrates an example embodiment of a signal detection system 500 that includes an alert tool implemented by way of a web-enabled computer system. The computer system includes a data source layer that may include one or more hosted databases 510. The hosted databases are typically updated infrequently and may be less complete than a transactional version of the databases. However, the hosted databases can be readily accessed in an on-demand fashion to efficiently evaluate potential signals. The computer system also includes a query layer with which a user interfaces and a web service layer that communicates information between the data source layer and the query layer.

In the query layer, the user chooses one or more data mining algorithms (block 520) that correspond to quantitative AE data analysis. The user also chooses target databases (block 525). The user also specifies a schedule for performing the data mining algorithms as well as other parameters, such as alert criteria that, when met, should result in an output case series (block 530). When a scheduled run-time occurs, the query layer sends the selected data mining algorithm, target databases, and parameters to the data source layer (block 535, block 540). If the user specifies a Boolean combination of AE data analysis results in blocks 520-530, the query layer sends the additional algorithm, target databases, and parameters to the data source layer (block 560, block 565).

The data source layer runs the algorithm(s), according to the parameters, on the specified target databases (block 545) and generates a result set(s) (block 550). The data source layer sends the results set(s) to the query layer (block 555) where the results are entered into an activity log (block 570). If alert criteria are met (block 575) the web service layer requests results (block 580). In response, the data source layer sends the results set(s) to the query layer (block 585). The query layer then displays the case series that meets the alert criteria to the user (block 590).

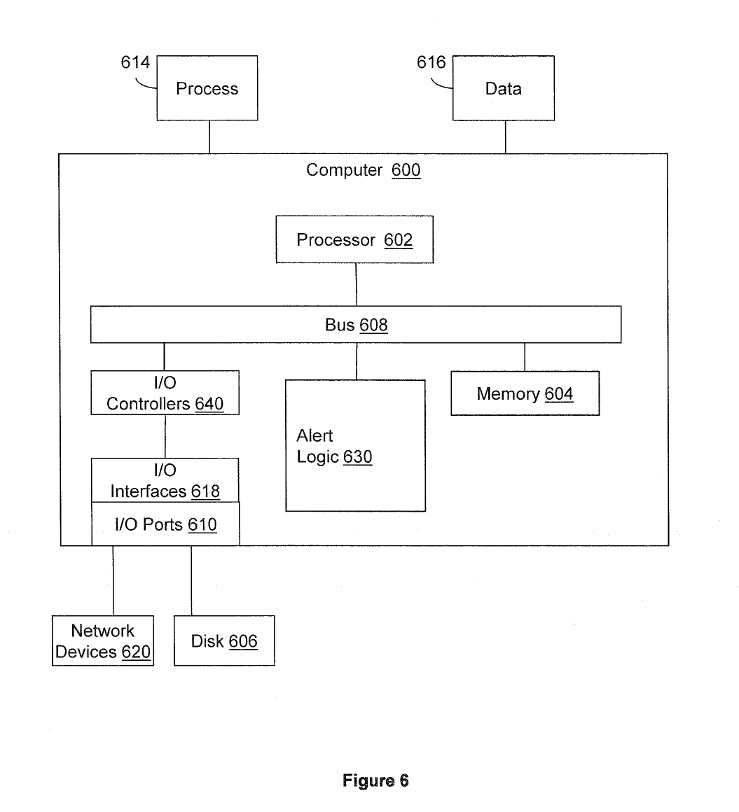

FIG. 6 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include an alert logic 630 configured to facilitate data rationalization. In different examples, the alert logic 630 may be implemented in hardware, software stored as computer executable instructions on a computer-readable medium, firmware, and/or combinations thereof. While the alert logic 630 is illustrated as a hardware component attached to the bus 608, it is to be appreciated that in one example, the alert logic 630 could be implemented in the processor 602.

Thus, alert logic 630 may provide means (e.g., hardware, instructions stored as computer executable instructions on a computer-readable medium, firmware) for monitoring AE data analysis output from multiple instances of AE data analysis; and means (e.g., hardware, instructions stored as computer executable instructions on a computer-readable medium, firmware) for allowing construction of an alert criteria that includes a combination of AE data analysis output from at least two different instances of AE data analysis on one or more data sources.

The means may be implemented, for example, as an ASIC (application specific integrated circuit) programmed to assess the alert criteria on selected data sources. The means may also be implemented as computer executable instructions that are presented to computer 600 as data 616 that are temporarily stored in memory 604 and then executed by processor 602.

Alert logic 630 may also provide means (e.g., hardware, instructions stored as computer executable instructions on a computer-readable medium, firmware) for outputting a case series that meets the alert criteria.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM (read only memory), PROM (programmable ROM), and so on. Volatile memory may include, for example, RAM (random access memory), SRAM (synchronous RAM), DRAM (dynamic RAM), and so on.

A disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM (compact disk) drive, a CD-R (CD recordable) drive, a CD-RW (CD rewriteable) drive, a DVD (digital versatile disk and/or digital video disk) ROM, and so on. The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCI (peripheral component interconnect), PCIE (PCI express), 1394, USB (universal serial bus), Ethernet). The bus 608 may communicate with I/O controllers 640 that control the I/O interfaces 610. The bus 608 can be types including, for example, a memory bus, a memory controller, a peripheral bus, an external bus, a crossbar switch, and/or a local bus.

The computer 600 may interact with input/output devices via the I/O interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the I/O interfaces 618, and/or the I/O ports 610. Through the network devices 620, the computer 600 may interact with a network. Through the network, the computer 600 may be logically connected to remote computers. Networks with which the computer 600 may interact include, but are not limited to, a LAN (local area network), a WAN (wide area network), and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method, comprising:
specifying an alert criteria corresponding to desired results of at least two different instances of AE data analysis;
assessing the alert criteria on at least one data source; and
outputting a case series that meets the alert criteria.

2. The computer-implemented method of claim 1 where specifying the alert criteria comprises specifying desired results of multiple instances of quantitative data analysis.

3. The computer-implemented method of claim 1 where specifying the alert criteria comprises specifying desired results of multiple instances of qualitative data analysis.

4. The computer-implemented method of claim 1 where specifying the alert criteria comprises specifying desired results of multiple instances of quantitative data analysis and qualitative data analysis.

5. The computer-implemented method of claim 1 where specifying the alert criteria comprises constructing a Boolean combination of desired results from the at least two different instances of AE data analysis.

6. The computer-implemented method of claim 1 comprising:
specifying a trigger criteria corresponding to desired results of a first instance of AE data analysis; and
initiating a predetermined second instance of AE data analysis when the trigger criteria is met.

7. The computer-implemented method of claim 6 where the specifying a trigger criteria comprises specifying a qualitative data analysis and where initiating a predetermined second instance of AE data analysis comprises initiating a quantitative data analysis.

8. A computing system, comprising:
an alert tool interface configured to construct an alert criteria corresponding to desired results of at least two instances of AE data analysis;
a criteria evaluation logic configured to assess the alert criteria on at least one data source; and
an alert mechanism logic configured to output a case series that meets the alert criteria.

9. The computing system of claim 8 where the at least two instances of AE data analysis comprise quantitative data analysis.

10. The computing system of claim 8 where the at least two instances of AE data analysis comprise qualitative data analysis.

11. The computing system of claim 8 where the at least two instances of AE data analysis comprise quantitative and qualitative data analysis.

12. The computing system of claim 8 where the alert criteria comprises a Boolean combination of desired results from the least two instances of AE data analysis.

13. The computing system of claim 8 comprising:
a trigger interface that is configured to construct a trigger criteria that comprises a first instance of AE data analysis;
a trigger evaluation logic to compare results of the first instance of AE data analysis to the trigger criteria; and
a trigger mechanism configured to initiate a predetermined second instance of AE data analysis when the trigger criteria is met.

14. The computing system of claim 13 where the first instance of AE data analysis comprises qualitative data analysis and the predetermined second instance of AE data analysis comprises quantitative data analysis.

15. The computing system of claim 8 where:
the alert tool interface comprises means for allowing construction of an alert criteria that comprises desired results from at least two different instances of AE data analysis;
the criteria evaluation logic comprises means for comparing the results from the at least two instances of AE data analysis to the alert criteria; and
the alert mechanism logic comprises means for outputting a case series that meets the alert criteria.

16. A non-transitory computer-readable medium storing computer-executable instructions that when executed by a computer cause the computer to perform a method, the method comprising:
specifying an alert criteria corresponding to desired results of at least two different instances of AE data analysis;
assessing the alert criteria on at least one data source; and
outputting a case series that meets the alert criteria.

17. The non-transitory computer-readable medium of claim 16 where the specifying comprises constructing a Boolean combination of desired results from the at least two different instances of AE data analysis.

18. The non-transitory computer-readable medium of claim 16 comprising:
specifying a trigger criteria corresponding to desired results of at least a first instance of AE data analysis; and
initiating a predetermined second instance of AE data analysis when the trigger criteria is met.

19. The non-transitory computer-readable medium of claim 18 where specifying the trigger criteria comprises specifying a qualitative data analysis and where initiating a predetermined second instance of AE data analysis comprises initiating a quantitative data analysis.
